(19) United States
(12) Patent Application Publication
(10) Pub. No.: US 2026/0126291 A1
(43) Pub. Date: May 7, 2026

(54) SPATIAL ORIENTATION INDICATION DEVICE

(71) Applicant: Tilak SRINIVASAN, Bangalore (IN)

(72) Inventor: Tilak SRINIVASAN, Bangalore (IN)

(21) Appl. No.: 19/121,811

(22) PCT Filed: Oct. 20, 2023
(86) PCT No.: PCT/IB2023/060614

§ 371 Date: Apr. 17, 2025

(30) Foreign Application Priority Data
Oct. 20, 2022 (IN) 202241060083

(51) Int. Cl. G01C 21/16; G01B 21/22

(52) U.S. Cl. CPC G01C 21/165; G01B 21/22

(57) ABSTRACT

The present disclosure related to a spatial orientation indication device (SOID) (100) for an object. The device (100) comprises an internal inputs module (106), an external inputs module (107) and a thrust inputs module (108). The device further includes an internal inputs processing unit (101), an external inputs processing unit (102) and a thrust inputs processing unit (103). A combined inputs processing unit (104) disclosed and associated with the internal inputs processing unit (101), the external inputs processing unit (107) and the thrust inputs processing unit (103) is configured to receive and process inputs related to the displacement parameters, the ambient parameters and the thrust and compare with a pre-defined spatial orientation data associated with each combination of displacement parameters, ambient parameters and thrust parameters a digital display (105) configured to display spatial orientation of the object based on the comparison by the combined inputs processing unit (104).

### TECHNICAL FIELD

Present disclosure generally relates to the field of measuring and processing devices. Particularly, but not exclusively, the present disclosure relates to a device for determination of spatial orientation of objects which are air bound.

### BACKGROUND OF THE DISCLOSURE

Inertial measurements of an object are important in achieving stabilization of the object which is subjected to motion. Conventionally, an array of stabilization systems is used in order to provide stability to a moving object. With advancements in technology, devices such as but not limiting to gyroscopes, gimbal etc., are used in applications such as but not limiting to vehicles, ships, submarines, aircraft and the like to determine the pitch, roll and yaw axes. This plays a role in orienting and positioning the vehicle/aircraft and also aids in maneuverability.

A gyroscope works on the principle of angular momentum which basically is the amount of rotation that an object may have, taking into account of mass and shape of the object. In simple words it is the vector quantity that represents the product of a body's rotational inertia and rotational velocity about a particular axis. Gyroscopes are of different types based on the different operating principles on which they adapt to.

Generally, gyroscopes such as the electronic, microchip-packaged MEMS gyroscope devices, solid-state ring lasers, fibre optic gyroscopes, and the extremely sensitive quantum gyroscope are known in the art. Their applications range from a variety of devices such as electronic gadgets to vehicles such as cars, ships and aircrafts. However, one of the major disadvantages of the gyroscope is its pan and tilt rotation speed. When the gyroscope is subjected to tilt and pan above the prescribed limit, the gyro fails to determine the orientation, this is seen in many of the electronic gadgets. However, not all gyroscopes and gimbals employed in electronic devices and vehicles have aforesaid disadvantages and ones without these flaws are expensive to manufacture.

Secondly, the gyroscopes and gimbals have complex result obtaining techniques, and as already mentioned are very expensive to manufacture which is undesired.

The present disclosure is directed to overcome one or more limitations stated above. The information disclosed in this background of the disclosure section is only for enhancement of understanding of the general background of the invention and should not be taken as an acknowledgment or any form of suggestion that this information forms the prior art already known to a person skilled in the art.

### SUMMARY OF THE DISCLOSURE

One or more shortcomings of the conventional systems are overcome, and additional advantages are provided through the present disclosure. Additional features and advantages are realized through the techniques of the present disclosure. Other embodiments and aspects of the disclosure are described in detail herein and are considered a part of the claimed disclosure.

In an embodiment of the present disclosure, a spatial orientation indication device (SOID) for an object is disclosed. The device comprises an internal inputs module configured to measure one or more displacement parameters of the control surface of the object. The device includes an external inputs module configured to measure one or more ambient parameters surrounding the object. The device also includes a thrust inputs module configured to measure one or more thrust parameters of the object. Further, an internal inputs processing unit associated with the internal inputs module is disclosed. The internal inputs processing unit is configured to process the one or more displacement parameters from the internal inputs module. An external inputs module associated with the external inputs module is disclosed. The external inputs processing unit is configured to process the one or more ambient parameters of the surroundings of the object from the external inputs module. Furthermore, a thrust inputs processing unit associated with the thrust inputs module is disclosed. The thrust inputs processing unit is configured to receive the one or more thrust parameters of the object from the thrust inputs module. Further, a combined inputs processing unit associated with the internal inputs processing unit, the external inputs processing unit and the thrust inputs processing unit is disclosed. The combined inputs processing unit is configured to receive and process inputs related to the displacement parameters, the ambient parameters and the thrust parameters from one each of the internal inputs module, the external inputs module, and the thrust inputs processing unit respectively and compare with a pre-defined spatial orientation data associated with each combination of displacement parameters, ambient parameters and thrust parameters. Additionally, at least one digital display is disclosed and configured to display spatial orientation of the object based on the comparison by the combined inputs processing unit.

In an embodiment, the internal inputs module includes a plurality of position sensors located on at least one of the primary control surface, the secondary control surface and the auxiliary control surface of the object.

In an embodiment, the plurality of position sensors includes linear displacement sensor and angular displacement sensor to measure linear displacement of the control surfaces and angular displacement of the control surfaces respectively.

In an embodiment, the plurality of position sensors are placed on mechanical links between the control surface and flight controls in the cockpit of the object.

In an embodiment, the external inputs module includes a plurality of air density sensors, air temperature sensors and air speed measuring sensors to measure air density, air temperature and air speed outside the object respectively.

In an embodiment, the thrust inputs module is configured to receive data regarding quantum of thrust and direction of thrust from a plurality of voltage sensors, current sensors and electromechanical sensors located in the communicative coupling between a cockpit and engine of the object.

In an embodiment, the object is an aerial vehicle.

In an embodiment, a reference point of the position sensors is set to zero, when the object is in a static grounded configuration.

In an embodiment, direction of thrust is supplied to the thrust inputs module during thrust vectoring.

In an embodiment, the pre-defined spatial orientation data corresponds to flight simulation data carried on the object using a standard combination of displacement parameters, ambient parameters and thrust parameters.

### BRIEF DESCRIPTION OF THE ACCOMPANYING DRAWINGS

The novel features and characteristic of the disclosure are set forth in the disclosure. The disclosure itself, however, as well as a preferred mode of use, further objectives, and advantages thereof, will best be understood by reference to the following description of an illustrative embodiment when read in conjunction with the accompanying figures. One or more embodiments are now described, by way of example only, with reference to the accompanying figures wherein like reference numerals represent like elements and in which:

FIG. 1 illustrates a block diagram of a spatial orientation indication device, in accordance with an embodiment of the present disclosure.

FIG. 2 illustrates a block diagram of an internal input module receiving displacement parameters from various control surfaces, in accordance with an embodiment of the present disclosure.

FIG. 3 illustrates a block diagram of an external inputs module receiving ambient parameters from various sensors, in accordance with an embodiment of the present disclosure.

FIG. 4 illustrates a block diagram of an thrust inputs module receiving thrust parameters from various sensors, in accordance with an embodiment of the present disclosure.

The figure depicts embodiment of the disclosure for purposes of illustration only. One skilled in the art will readily recognize from the following description that alternative embodiments of the system and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood.

Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent processes do not depart from the scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure. It will be readily understood that the aspects of the present disclosure, as generally described herein, and illustrated in the figures, can be arranged, substituted, combined, and designed in a wide variety of different configurations, all of which are explicitly contemplated and make part of this disclosure.

It is to be noted that a person skilled in the art would be motivated from the present disclosure and modify the device and/or the components involved in the device. However, such modification should be construed within the scope of the present disclosure. Accordingly, the drawings show only those specific details that are pertinent to understand the embodiments of the present disclosure so as not to obscure the disclosure with details that will be readily apparent to those of ordinary skill in the art having benefit of the description herein.

The terms “comprises”, “comprising”, or any other variations thereof used in the disclosure, are intended to cover a non-exclusive inclusion, such that a device, a mechanism, a system, and a method, that comprises a list of components does not include only those components but may include other components not expressly listed or inherent to such system, or assembly, or device, or mechanism. In other words, one or more elements in a device, a system or an assembly proceeded by “comprises . . . a” does not, without more constraints, preclude the existence of other elements or additional elements in the device or the system or the mechanism.

To overcome the limitations stated in the background, the present disclosure provides an orientation indication device. The orientation indication device may also be termed as a spatial orientation indication device (SOID) which may be employed for determining the orientation of an object about three mutually perpendicular axes. The three mutually perpendicular axes being pitch, roll and yaw axes or X, Y and Z axis of an object. The orientation indication device in the present disclosure is configured in such a way that it determines the orientation of the objects such as but not limited to objects including aircraft.

The spatial orientation indication device (SOID) comprises a plurality of position sensors mounted on control surfaces of an object. The plurality of position sensors are configured to determine linear and angular displacement of the control surfaces with respect to a reference point. The device includes an internal inputs module configured to measure one or more displacement parameters of the control surfaces such as linear displacement and angular displacement of control surfaces. The device further includes an external inputs module configured to measure one or more ambient parameters of the environment such as air density, air temperature, air speed, etc. The device includes a thrust inputs module to monitor quantum/direction of thrust from the engine. The device further includes an internal inputs processing unit, an external inputs processing unit and a thrust inputs processing unit. The internal inputs processing unit is configured to receive and process the inputs from the internal inputs module associated with displacement parameters of the control surfaces of the object. The external inputs processing unit is configured to receive and process the inputs from the external inputs module associated with ambient parameters of the environment of the object. The thrust inputs processing unit is configured to receive and process the inputs from the thrust inputs module associated with thrust parameters of the object. The object further includes a combined inputs processing unit associated with the internal inputs processing unit, the external inputs processing unit, and the thrust inputs processing unit to receive inputs signals. Further, various permutations and/or combinations of the displacement parameters, the ambient parameters and thrust parameters are compared with a pre-defined spatial orientation data associated with each combination of displacement parameters, ambient parameters and thrust parameters. The device further includes at least one display unit that is configured to display the spatial orientation of the object based on the comparison by the combined inputs processing unit.

Reference will now be made to the exemplary embodiments of the disclosure, as illustrated in the accompanying drawings. Wherever possible, same numerals will be used to refer to the same or like parts. Embodiments of the disclosure are described in the following paragraphs with reference to FIG. 1, the same element or elements which have same functions are indicated by the same reference signs.

FIG. 1 is an exemplary embodiment of the present disclosure which illustrates a spatial orientation indication device (SOID) (100) in the form of a block diagram. The device (100) includes a plurality of input modules (106, 107, 108), a plurality of inputs processing units (101, 102, 103, 104) and at least one display unit (105). The plurality of input modules (106, 107, 108) are the internal inputs module (106), external inputs module (107), and thrust input module (108). The inputs module (106, 107, 108) may be mounted or embedded on a surface of an object such as but not limited to surface of an aerial vehicle.

In an embodiment, the object may include an engine configured to provide thrust to the object.

In an embodiment, the object may include a cockpit provisioned to accommodate a plurality of control units for monitoring and controlling the spatial orientation of the object.

In an embodiment, the engine and at least one of the plurality of control units may be communicatively coupled with each other.

In an embodiment, the cockpit of the object may include a plurality of control devices to control the orientation of the object. In an embodiment, a plurality of sensors may be located in the cockpit of the object to detect change in movement of the control devices of the cockpit and thereby detect change in spatial orientation.

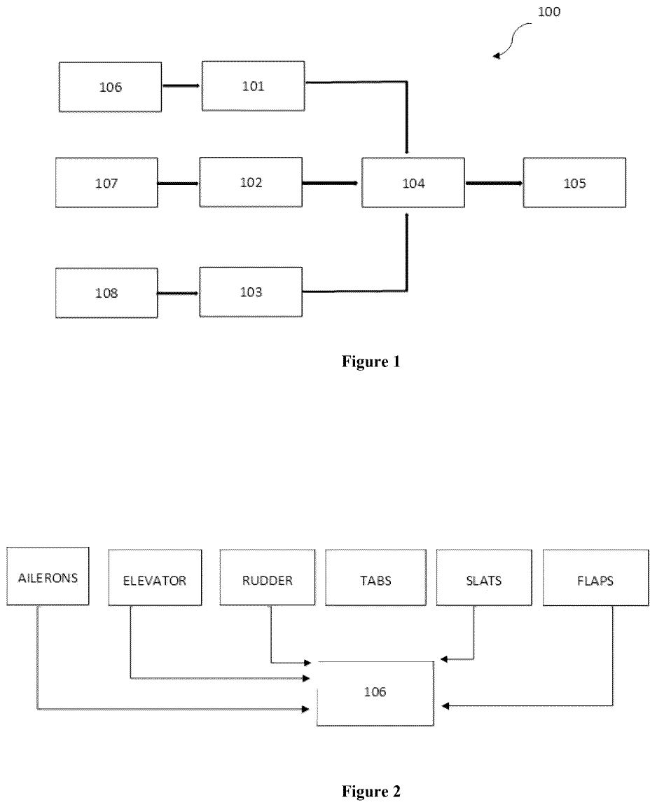

The internal inputs module (106) may be configured to measure one or more displacement parameters of the object. The internal inputs module (106) may include a plurality of position sensors, angular displacement sensors configured to obtain the displacements of the control surfaces of the object. In an embodiment a control surface may be defined as elements of an aerial vehicle used to maneuver the aerial vehicle. Further, the control surface comprises a primary control surface, a secondary control surface and an auxiliary control surface. In an embodiment the primary control surface for an aircraft may include ailerons, elevator and rudder [As seen in FIG. 2]. In an embodiment a secondary control surface may include tabs, slats and flaps [As seen in FIG. 2].

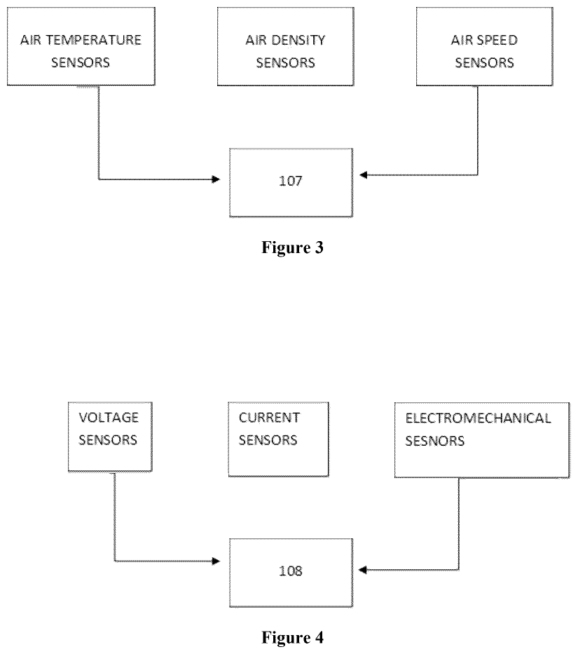

The external inputs module (107) may be configured to measure one or more ambient parameters of the object. The external inputs module (107) may include a plurality of air temperature sensors, air density sensors, air speed sensors [as seen in FIG. 3] configured to measure air density, air temperature and air speed outside the object respectively. Further, the thrust inputs module (108) may be configured to measure thrust parameters of the object. The thrust inputs module (108) may include a plurality of voltage sensors, current sensors and electromechanical sensors configured to measure quantum of thrust and direction of thrust from the engine.

The device (100) further includes an internal inputs processing unit (101), an external inputs processing unit (102) and a thrust inputs processing unit (103) to receive and process the inputs from the internal inputs module (106), the external inputs module (107) and the thrust inputs module (108). The internal inputs processing unit (101) may be configured to processes all the inputs from a plurality of position sensors located on the control surface of the object. The external input processing unit (102) processes all the inputs from the plurality of sensors including air temperature sensors, air density sensors, air speed sensors. The external inputs like air temperature, air, density, air speed, etc. are measured from the sensors which are embedded on the external surface of the body of the object. The thrust inputs processing unit (103) processes the thrust inputs parameters from the thrust inputs module (108). The thrust inputs processing unit (103) processes all inputs obtained from a plurality of sensors including voltage sensors, current sensors and electromechanical sensors [as seen in FIG. 4] located in the communicative coupling between the cockpit and the engine of the object. The combined inputs processing unit (104) processes the permutations and/or combinations of inputs from the internal inputs processing unit (101), the external input processing unit (102), and thrust inputs processing unit (103). Further, various permutations and/or combinations of the displacement parameters, the ambient parameters and the thrust parameters from each of the internal inputs processing unit (101), the external inputs processing unit (102), and the thrust inputs processing unit (103) are fed into the combined inputs processing unit (104). The combined inputs processing unit (104) compares with all possible permutations and/or combinations of the inputs from the internal inputs processing unit (101), the external inputs processing unit (102), and the thrust inputs processing unit (103) with pre-defined spatial orientation data corresponding to flight simulation performed on the object using a standard combination of displacement parameters, ambient parameters and thrust parameters. In an embodiment, the internal inputs module (106), the internal inputs processing unit (101), the external inputs module (107), the external inputs processing unit (102), the thrust inputs module (108), the thrust inputs processing unit (103), combined inputs processing unit (104) and the digital display (105) may be powered by a power source.

The processed signals from the combined inputs processing unit (104) of each of the spatial orientations corresponding to the permutations and/or combinations of at least one each of the internal inputs processing unit (101), the external inputs processing unit (102), and the thrust inputs processing unit are fed into the digital display (105) and is configured to display spatial orientation of the object based on the comparison with a pre-defined spatial orientation data associated with each combination of displacement parameters, ambient parameters and thrust parameters by the combined inputs processing unit (104).

In an operational embodiment, the values of the internal input module (106) such as a plurality of position and angular displacement sensors, etc. are set to zero before the object is air-borne. Tracking of the object in a space is done by processing the inputs to the internal inputs module (106), the external inputs module (107), the thrust inputs module (108) by the internal inputs processing unit (101), the external inputs processing unit (102), and the thrust inputs processing unit (103). The permutation and/or combination of inputs from the internal inputs processing unit (101), the external inputs processing unit (102), and the thrust inputs processing unit (103) is fed into the combined inputs processing unit (104) for comparing with all possible permutations and/or combinations of the inputs from the internal inputs processing unit (101), the external inputs processing unit (102), and the thrust inputs processing unit (103). Such comparison is performed with pre-defined spatial orientation data corresponding to flight simulation performed on the object using a standard combination of displacement parameters, ambient parameters and thrust parameters. Further, the output of the combined inputs processing unit (104) is fed into the digital display (105) which displays/depicts the spatial orientation of the object.

In an embodiment, the thrust inputs module (108) is configured to provide thrust data to the thrust inputs processing unit (103). Further, during thrust vectoring, the data corresponding to the direction of thrust is provided to thrust inputs module (108). In an embodiment, thrust vectoring corresponds to the capability of an aerial vehicle to change direction of thrust from the engine to control the attitude or angular velocity of the aerial vehicle.

In an embodiment, in the case of Fly-by-wire (FBW), the internal inputs are given by a controller to the actuators of the aerial vehicle with no need of a plurality of position sensors. Therefore, usage of plurality of position sensors should not be construed as a limitation of the present disclosure.

In an embodiment, the device (100) may be located within the cockpit of the aerial vehicle. The device (100) may also be connected to an external power source or may be connected to a portable power source positioned within the device (100). In an embodiment, the object may be a maritime vehicle or an automobile.

Thus, the present disclosure offers an alternative to gyroscope based stabilization and indication for spatial orientation of an aerial object by using a plurality of position sensors.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding the description may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated in the description.

### REFERRAL NUMERALS

| Reference Number | Description |
|---|---|
| 100 | Spatial Orientation indication device |
| 101 | Internal inputs processing unit |
| 102 | External inputs processing unit |
| 103 | Thrust inputs processing unit |
| 104 | Combined inputs processing unit |
| 105 | Digital Display |
| 106 | Internal inputs module |
| 107 | External inputs module |
| 108 | Thrust inputs module |

1. A spatial orientation indication device (SOID) for an object, the device comprising:
an internal inputs module configured to measure one or more displacement parameters including linear displacement and angular displacement of a control surface of the object;
an external inputs module configured to measure one or more ambient parameters including air density, air temperature and air speed of surroundings of the object;
a thrust inputs module configured to measure one or more thrust parameters including quantum of thrust and direction of thrust of the object;
an internal inputs processing unit associated with the internal inputs module, the internal inputs processing unit is configured to process the permutations and/or combinations of the one or more displacement parameters of the control surface of the object;
an external inputs processing unit associated with the external inputs module, the external inputs processing unit is configured to process the permutations and/or combinations of the one or more ambient parameters of the surroundings of object from the external inputs module;
a thrust inputs processing unit associated with the thrust inputs module, the thrust inputs processing unit is configured to process the permutations and/or combinations of the one or more thrust parameters of the object from the thrust inputs module;
a combined inputs processing unit configured to receive and process the permutations and/or combinations of inputs related to the displacement parameters, the ambient parameters and the thrust parameters from one each of the internal inputs processing unit, the external inputs processing unit, and the thrust inputs processing unit and compare with a pre-defined spatial orientation data associated with each permutation and/or combination of displacement parameters, ambient parameters and thrust parameters; and
at least one digital display configured to display spatial orientation of the object based on the comparison by the combined inputs processing unit.

2. The device as claimed in claim 1, wherein the internal inputs module is configured to receive displacement parameters from a plurality of control surfaces of the object.

3. The device as claimed in claim 2, wherein the control surface comprises a primary control surface, a secondary control surface and an auxiliary control surface.

4. The device as claimed in claim 3, wherein the internal inputs module receives data from a plurality of position sensors located on at least one of the primary control surface, the secondary control surface and the auxiliary control surface of the object.

5. The device as claimed in claim 4, wherein the plurality of position sensors includes linear displacement sensor and angular displacement sensor to measure linear displacement of the control surfaces and angular displacement of the control surfaces respectively.

6. The device as claimed in claim 4, wherein the plurality of position sensors are placed on mechanical links between the control surface and flight controls in the cockpit of the object.

7. The device as claimed in claim 1, wherein the external inputs module includes a plurality of air density sensors, air temperature sensors and air speed measuring sensors to measure air density, air temperature and air speed outside the object respectively.

8. The device as claimed in claim 1, wherein the thrust inputs module is configured to receive data regarding quantum of thrust and direction of thrust from a plurality of voltage sensors, current sensors and electromechanical sensors located in the communicative coupling between a cockpit and engine of the object.

9. The device as claimed in claim 1, wherein the object is an aerial vehicle.

10. The device as claimed in claim 4, wherein a reference point of the plurality of position sensors is set to zero, when the object is in a static grounded configuration.

11. The device as claimed in claim 1, wherein direction of thrust is supplied to the thrust inputs module during thrust vectoring.

12. The device as claimed in claim 1, wherein the pre-defined spatial orientation data corresponds to flight simulation data carried on the object using a standard combination of displacement parameters, ambient parameters and thrust parameters.
